(19) United States
(12) Patent Application Publication
(10) Pub. No.: US 2009/0058827 A1
(43) Pub. Date: Mar. 5, 2009

(54) INFORMATION PROCESSING DEVICE, METHOD AND PROGRAM

(75) Inventor: Yoshihiro Kaneko, Fussa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/176,752

(22) Filed: Jul. 21, 2008

(30) Foreign Application Priority Data
Aug. 31, 2007 (JP) 2007-226773

(51) Int. Cl. G06F 3/041

(52) U.S. Cl. 345/173

(57) ABSTRACT

According to one embodiment, the information processing device includes a display provided with a touch sensor on a display surface thereof, a virtual display section capable of virtually displaying an area larger than a maximum display area of the display, a mode switch section configured to switch the display from a first mode in which the maximum display area of the display is presented to a second mode in which an area of a screen of the virtual display section, and a display area panning section configured to, when the display is switched to the second mode and when the touch sensor detects that one of predetermined areas of the display is touched, pan the display area so that a not-shown area of the virtual display section that corresponds to the touched area is presented on the display.

### CROSS-REFERENCE TO RELATED APPLICATIONS

This application is based upon and claims the benefit of priority from the prior Japanese Patent Application No. 2007-226773, filed Aug. 31, 2007, the entire contents of which are incorporated herein by reference.

### BACKGROUND

1. Field

One embodiment of the present invention pertains to an information processing device such as a personal computer, particularly to an information processing device having a virtual display function, and an information processing method and program.

2. Description of the Related Art

In comparison with a desktop personal computer, an information device such as a mobile computer or a personal digital assistant (PDA) generally has a small display because only a small screen can be mounted thereon.

Jpn. Pat. Appln. KOKAI Publication No. 2004-272906, for example, shows a technique of expanding the display area by providing a virtual screen such as a virtual display. When panning to an area of the virtual display that cannot be viewed on the display by using this technique, a window showing the entire area of the virtual display (hereinafter, referred to as “map pane”) is separately displayed so that a specific position in this window can be designated. Panning to the corresponding area on the virtual display can be realized in this manner.

In screen panning by use of a map pane, however, the map pane needs to be presented on the small display of the information device, which makes the operation rather inconvenient.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a computer according to an embodiment of the present invention.

FIG. 2 is an exemplary block diagram of an example system structure of the computer according to the embodiment.

FIG. 3 is an exemplary block diagram of the functional structure of a display application according to the embodiment.

FIG. 4 is an exemplary flowchart showing an information processing method to which the computer according to the embodiment is applied.

FIG. 5 is an exemplary schematic diagram of a virtual display function.

### DETAILED DESCRIPTION

Various embodiments according to the invention will be described hereinafter with reference to the accompanying drawings. In general, according to one embodiment of the invention, an information processing device includes: a display provided with a touch sensor on a display surface thereof; a virtual display section capable of virtually displaying an area larger than a maximum display area of the display; a mode switch section configured to switch the display from a first mode in which the maximum display area of the display is presented to a second mode in which an area of a screen of the virtual display section that is to be presented on the display is designated; and a display area panning section configured to, when the display is switched to the second mode and when the touch sensor detects that one of predetermined areas of the display is touched, pan the display area so that a not-shown area of the virtual display section that corresponds to the touched area is presented on the display.

Exemplary embodiments of the present invention will be explained with reference to the attached drawings.

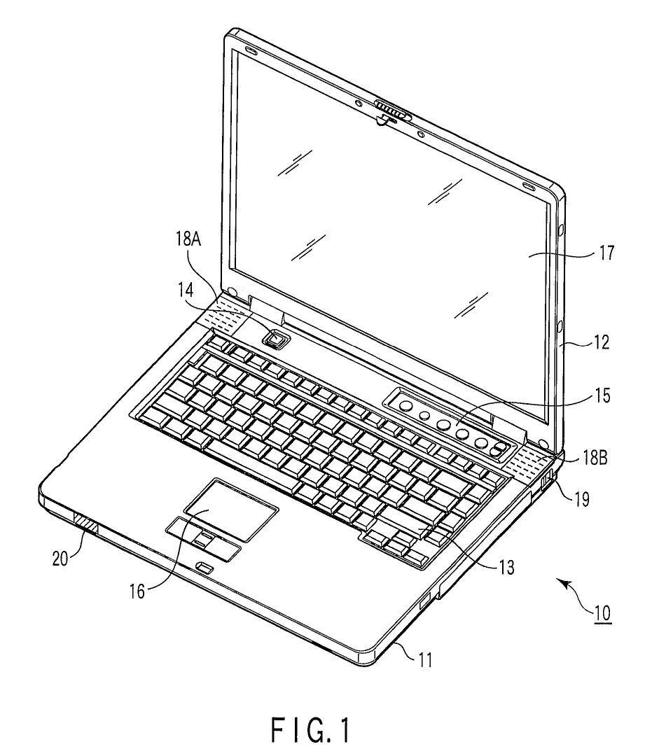

First, the structure of an information processing device according to an embodiment of the present invention will be described with reference to FIGS. 1 to 3. This information processing device is realized, for example, in the form of a small notebook sized personal computer 10.

FIG. 1 is a perspective view of the notebook personal computer 10 with its display unit open. The computer 10 comprises a computer main body 11 and a display unit 12. The display unit 12 includes a display device formed of a thin film transistor liquid crystal display (TFT-LCD) 17 in which a touch sensor is incorporated to detect the coordinates of a point of the display surface touched by a finger or the like. The display screen of the LCD 17 is arranged substantially in the center of the display unit 12. The computer 10 may be of a tablet type with the display unit 12 arranged in a rotatable manner.

The display unit 12 is arranged rotatably between the open position and the closed position with respect to the computer main body 11. The computer main body 11 has a thin box housing, on the top surface of which a keyboard 13, a power switch 14 for switching the computer 10 on/off, an input operation panel 15, a touch pad 16, loudspeakers 18A and 18B, an infrared receiving section 20 and the like are arranged.

The input operation panel 15 is an input device through which an event corresponding to a pressed button is entered, and is provided with a number of buttons to activate different functions.

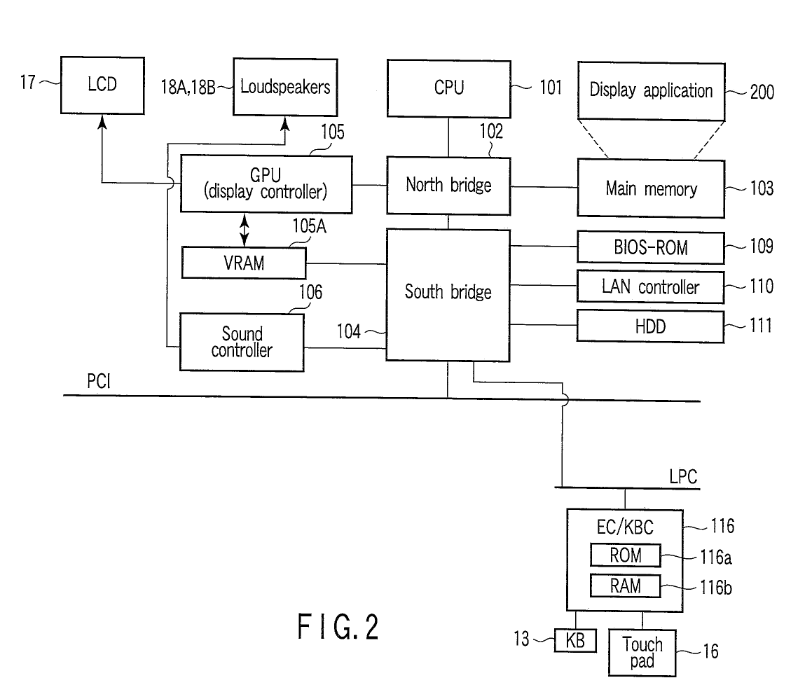

Next, the system structure of the computer 10 will be described with reference to FIG. 2.

As illustrated in FIG. 2, the computer 10 comprises a CPU 101, a north bridge 102, a main memory 103, a south bridge 104, a GPU 105, a BIOS-ROM 109, a LAN controller 110, a hard disk drive (HDD) 111, an embedded controller/keyboard controller IC (EC/KBC) 116, a keyboard (KB) 13, and the like. Furthermore, the embedded controller/keyboard controller IC (EC/KBC) 116 includes a ROM 116a and a RAM 116b.

The CPU 101 is a processor that controls the operation of the computer 10, and executes an operating system, a display application 300 and the like that are loaded from the hard disk drive (HDD) 111 to the main memory 103. The CPU 101 also executes the basic input output system (BIOS) stored in the BIOS-ROM 109. The BIOS is a hardware control program.

The north bridge 102 is a bridge device that connects the local bus of the CPU 101 and the south bridge 104. The north bridge 102 contains a memory controller that controls accesses to the main memory 103. Moreover, the north bridge 102 is provided with a function of communicating with the GPU 105 by way of the PCI Express-standard serial bus or the like.

The GPU 105 is a display controller that controls the LCD 17 used as the display monitor of the computer 10. A display signal generated by this GPU 105 is sent to the LCD 17. A signal received from the touch sensor of the LCD 17 is sent to the CPU 101 by way of the GPU 105.

The south bridge 104 controls the devices on the Low Pin Count (LPC) bus and the devices on the Peripheral Component Interconnect (PCI) bus. The south bridge 104 also contains an Integrated Drive Electronics (IDE) controller that controls the HDD 111.

The embedded controller/keyboard controller IC (EC/KBC) 116 is a one-chip microcomputer integrating an embedded controller that manages the power consumption and a keyboard controller that controls the keyboard (KB) 13 and the touch pad 16. The embedded controller/keyboard controller IC (EC/KBC) 116 is provided with a function of switching the computer 10 on/off in accordance with the user's operation of the power switch 14.

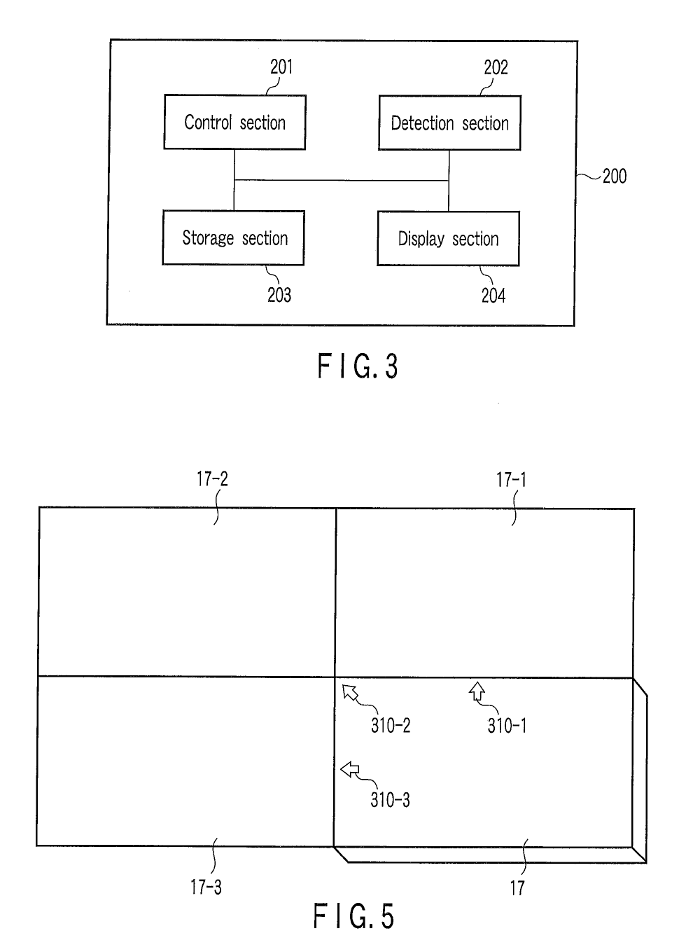

FIG. 3 is a block diagram indicating the functional structure of the display application 300 of the information processing device according to the embodiment of the present invention.

The display application 300 comprises a control section 201, a detection section 202, a storage section 203, a display section 204 and the like.

The control section 201 controls panning within the virtual display area in accordance with the part of the LCD 17 that has been pressed down. The detection section 202 monitors the pressed down position of the LCD 17 and the period of time of being pressed down (whether the position has been pressed down for a certain length of time). The storage section 203 stores threshold information of the pressed down period and the like. The display section 204 presents an area of the virtual display after panning or the originally displayed area, move buttons, and the like on the LCD 17.

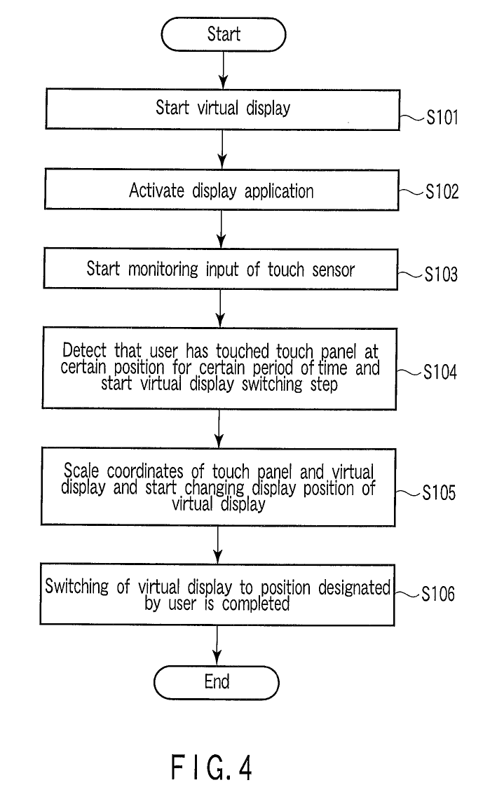

Next, an information processing method to which the information processing device according to the embodiment of the present invention is applied will be explained with reference to the flowchart of FIG. 4.

When the computer 10 is activated, a preset virtual display function is started (Block S101). For example, as indicated in FIG. 5, areas 17-1, 17-2 and 17-3, which are larger than the area displayed on the LCD 17, can be displayed with the virtual display function. Here, the area of the LCD 17 is the original display area, while the areas 17-1, 17-2 and 17-3 are virtual display areas.

Then, the display application 300 is started by the user operating the start switch or a menu. The display application 300 is loaded from the HDD 111 onto the main memory 103 and executed (Block S102). The display application 300 is an application that is adopted to pan the areas of the virtual display.

The control section 201 of the display application 300 starts monitoring inputs from the touch sensor (touch panel) of the LCD 17 (Block S103).

When the detection section 202 of the display application 300 detects that the user presses a certain position of the touch panel (around the center of the panel, for example) for a certain period of time (for 5 seconds or longer, for example), a step of switching from a normal display mode (first mode) to a pan mode (second mode) is initiated (Block S104). At this moment, in the pan mode, buttons 310-1, 310-2 and 310-3 are presented to pan the display to any of the virtual display areas (see FIG. 5).

For example, when the detection section 202 of the display application 300 detects that the button 310-1 displayed on the touch panel is pressed down, the coordinates of the touch panel (LCD) 17 and the virtual display 17-1 are scaled, and the change of the display position of the virtual display 17-1 begins (Block S105). Then, the control section 201 of the display application 300 pans the view to the virtual display 17-1, which is the position designated (pressed down) by the user, and the virtual display 17-1 is displayed on the LCD 17 (Block S106). In other words, the display area is panned to the area of the virtual display that corresponds to the position pressed down on the display.

In the same manner, when the detection section 202 of the display application 300 detects that the button 310-2 (310-3) is pressed down on the touch panel, the coordinates of the touch panel (LCD) 17 and the virtual display 17-2 (17-3) are scaled, and the change of the display position of the virtual display 17-2 (17-3) begins. Then, the control section 201 of the display application 300 pans the view to the virtual display 17-2 (17-3), which is the position designated (pressed down) by the user, and the virtual display 17-2 (17-3) is displayed on the LCD 17.

As described above, according to the present embodiment, panning of the virtual display areas across the entire screen can be realized on a screen having a virtual display function by use of a touch sensor-equipped display. Furthermore, this virtual display function can be realized with a simple operation.

The present invention is not limited to the above embodiment, and the embodiment may be realized by modifying the structural components without diverting from the scope of the invention. Furthermore, various inventions can be achieved by suitably combining the aforementioned structural components. For instance, some of the structural components may be omitted from the embodiment. The structural components of different embodiments may be suitably combined.

The present invention has been conceived in light of the above circumstances. The present invention offers an information processing device that incorporates a virtual display function with which an operation is facilitated by use of the entire screen, as well as an information processing method and program.

According to the present invention, a virtual display function that requires only a simple operation by use of the entire screen can be realized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a display provided with a touch sensor on a display surface thereof;
a virtual display section capable of virtually displaying an area larger than a maximum display area of the display;
a mode switch section configured to switch the display from a first mode in which the maximum display area of the display is presented to a second mode in which an area of a screen of the virtual display section that is to be presented on the display is designated; and
a display area panning section configured to, when the display is switched to the second mode and when the touch sensor detects that one of predetermined areas of the display is touched, pan the display area so that a not-shown area of the virtual display section that corresponds to the touched area is presented on the display.

2. The information processing device according to claim 1, wherein buttons are presented in the predetermined areas to show panning directions of the display area.

3. The information processing device according to claim 1, wherein the touch is detected when the display surface of the display is touched for at least a predetermined length of time.

4. An information processing method adopted for an information processing device having a display provided with a touch sensor on a display surface thereof, comprising:
presenting a screen of a maximum display area of the display, which is a part of a screen on a virtual display section capable of virtually displaying an area larger than the maximum display area of the display, on the display;
receiving an instruction of switching the display from a first mode in which the screen of the maximum display area is presented to a second mode in which an area of the screen of the virtual display section that is to be presented on the display is designated;
detecting with the touch sensor that one of predetermined areas of the display is touched; and
panning the display area to a not-shown area of the virtual display section that corresponds to the detected area so that the not-shown area is presented on the display.

5. The information processing method according to claim 4, wherein, when switched to the second mode, buttons are displayed to show corresponding panning directions of the display area in the predetermined areas.

6. The information processing method according to claim 4, wherein in detection of the touch, a length of time of continuous touch of the display surface of the display is counted and the touch is detected when the length of time is equal to or greater than a predetermined length.

7. A program executed by a computer having a display provided with a touch sensor on a display surface thereon, the program causing the computer to implement procedures of:
presenting a screen of a maximum display area of the display, which is a part of a screen on a virtual display section capable of virtually displaying an area larger than the maximum display area of the display, on the display;
receiving an instruction of switching the display from a first mode in which the screen of the maximum display area is presented on the display to a second mode in which an area of the screen of the virtual display section that is to be presented on the display is designated;
detecting with the touch sensor that one of predetermined areas of the display is touched when the display is switched to the second mode; and
panning the display area to a not-shown area of the virtual display section that corresponds to the detected area so that the not-shown area is presented on the display.
